(19) United States
(12) Patent Application Publication
(10) Pub. No.: US 2010/0219204 A1
(43) Pub. Date: Sep. 2, 2010

(54) Insulated System for Dispensing a One-Component Polyurethane Foam

(75) Inventors: Michael C. Dean, Alpharetta, GA (US); Robert G. Braun, New Lenox, IL (US); Wesley E. Dils, III, El Paso, TX (US)

Correspondence Address: VEDDER PRICE P.C., 222 N. LASALLE STREET, CHICAGO, IL, 60601, US

(73) Assignee: DOW GLOBAL TECHNOLOGIES, INC., Midland, MI (US)

(21) Appl. No.: 12/675,352

(22) PCT Filed: Sep. 10, 2008
(86) PCT No.: PCT/US2008/075852

§ 371 Date: Feb. 25, 2010

Related U.S. Application Data
(60) Provisional application No. 60/971,474, filed on Sep. 11, 2007.

(51) Int. Cl. B67D 7/78; B67D 1/08; G01F 11/00

(52) U.S. Cl. 222/131; 222/148; 222/175; 222/183; 222/325

(57) ABSTRACT

The present disclosure relates to an insulated system for dispensing a one-component polyurethane foam, and more specifically, to a portable and insulated device for storing a plurality of small canisters of one-component polyurethane foam operating in tandem with a handheld dispenser gun. What is contemplated is the use of a handheld insulated box, such as a industrial cooler, or a cardboard box, such as a storage and delivery box with slit openings for operation with flexible fixation straps, used in association with a belt holster with clip-on docketing stations for operation of a plurality of OCF canisters in an insulated environment. To protect from possible blockage of internal sections of a manifold by cooled OCF, different configurations of manifold, such as a C shape or a star shape, are contemplated.

### FIELD OF THE DISCLOSURE

The present disclosure relates to an insulated system for dispensing a one-component polyurethane foam, and more specifically, to a portable and insulated device for storing and dispensing a plurality of small canisters of one-component polyurethane foam protected from weathering conditions by an insulated container and a nonlinear manifold design.

### BACKGROUND

Polyurethane is a polymer made of a chain of organic units joined by urethane links. Polyurethane is solidified during a curing process and cannot be transformed back into a liquid or separated into its basic units at normal operating temperatures. This polymer is used a wide range of applications using both flexible and rigid polymers, such as foams, elastomers, high-performance adhesives, sealants, fibers, seals, gaskets, and other applications. There are numerous applications in which polyurethane foam is used, including the construction industry, where this product is used as insulation and filler for spaces of different volumes.

Solidified foams generally serve as good insulating materials. The solid matrix is filled with pellets of gas that limit heat conduction. Polymers such as polyurethane are also weak electrical conductors and serve as a barrier to thermal heat. Polyurethane foams are used in many applications, including household and commercial refrigerators and freezers, building insulation and roofing, doors, cushioning, packaging, sprays, and marine flotation. Foams may be used as insulators or fillers in closed bodies, such as a sealant in the building trades for spaces between window and door frames and the like, and as an adhesive for glueing flooring, roofing tiles, and the like. For polyurethane foams, the main reaction is between a diisocyanate and a polyol in the presence of a catalyst for controlling the cell structure of the foam. By varying the type of monomer used and by using additives, the characteristics of the foam, such as the density, hardness, and rigidity, can be modified. Polyurethane foam is usually made by adding small amounts of blowing agents to the reaction mixture. Blowing agents include acetone, methylene chloride, or more sophisticated fluorocarbons, which yield important performance characteristics, primarily for thermal insulation.

Polyurethane foam for in situ applications is typically supplied as a one-component froth foam (“OCF”) or a two-component froth foam. The most common types of polyurethane sources are one- and two-component foams. In two-component polyurethane foam systems, the organic polyol, the catalyst foaming agent, and the additives are kept next to an isocyanate. The components are mixed to produce a rapidly expanding foam with an important expansion coefficient. This expansion can be cured by controlling the temperature and the humidity level at the phasic interface. In the case of two-component polyurethane foam systems, one component is supplied in one pressurized container, typically the “A” container (e.g., polymeric isocyanate, fluorocarbons, etc), while the resin is supplied in a second pressurized container, typically the “B” container (e.g., polyols, catalyst, flame retardants, etc.). Typically, two-components kits use pressurized cylinders about 7½ inches in diameter, which are connected by hoses to a dispensing gun where the components are mixed to create foam. One of the advantages of the two-component system is the relatively long shelf life resulting from the fact that the chemicals are not mixed until they encounter each other in the dispensing gun. These components are also not subject to curing and chemical transformation within their respective containers and are less subject to degradation when stored in a variable temperature environment. These components also do not block distribution nozzles when the resulting compound is formed.

Alternatively, for OCF, the resin and the isocyanate for the foam is supplied in a single pressurized container and dispensed from the container through a valve or gun attached to the container. OCF is best suited to smaller applications, since it generally has a smaller expansion coefficient (3 to 1) over two-component foam (8 to 1). The resulting foam is denser and more heat conductive but offers better structural support at the dispensed location. Foams with smaller expansion coefficients are also easier to apply. As a result, most OCF is available for use in a small can or pressurized cylinder.

Existing products are intended for filling and insulating small cracks and voids in and around air conditioners, outlets, pipes, conduits, heating ducts, and other spaces between building products. When pressurized, OCF does not cure or rigidify until it is released from the container and reaches the right ratio of temperature and pressure. Optimal production of polyurethane foam includes the mixing of the two components into a single product, the addition of heat to adjust the temperature of a reactive level for polymerization, and pressurized carbon dioxine gas mixed into the product for filling in gaps within the matrix during polymerization. OCF cans or cylinders, after some degree of use, lose internal pressure and become vulnerable to degradation by partial local chemical transformation within the can, which can lead to suboptimal polymerization if inadequate temperatures are encountered.

As a general rule, OCF from a can cures tack-free in 10 minutes and is fully cured in 24 hours or fewer. Optimal application ranges between 65 deg. F. and 100 deg. F., but on a construction site, ambient temperature often drops well below or rises above these levels. Applying thermally sensitive foam under variable heat conditions can result in a loss of precise application by an operator. Existing OCF systems can also require transportation by an operater of a large volume of uncured component to a worksite to fill a certain volume, since OCF foam does not expand as much as two-component foam. If, for example, a user must fill a 24-gallon volume using a two-component foam with an expansion coefficient of 8, then 3 gallons of components is needed, whereas if an OCF foam with an expansion coefficient ratio of 3 is used, then 8 gallons are needed. In addition, pressure vessels of large size designed to hold a certain internal pressure require a thick skin to withstand the attendant forces. A large quantity of small cans are then best suited for transporting large quantities of OCF but result in the need for operators to manipulate, store, manage, and dispose of more waste and a plurality of containers.

What is needed is a system for applying OCF capable of optimal manipulation on a worksite and designed for storage and management of large quantities of small cans. What is also needed is an insulated system capable of maintaining the small cans within an acceptable range of temperatures while the user accesses difficult locations, such as on schaffolding or ladders, using a hand gun or other handheld device while dispensing the OCF. What is also needed is a system for applying OCF designed to withstand temperature variations while protecting from manifold blockage.

### SUMMARY

The present disclosure relates to an insulated system for dispensing a one-component polyurethane foam, and more specifically, to a portable and insulated device for storing a plurality of small canisters of one-component polyurethane foam operating in tandem with a handheld dispenser gun. What is contemplated is the use of a handheld, insulated box, such as a industrial cooler, cardboard box, or a storage and delivery box with slit openings using flexible fixation straps, which is used in association with a belt holster with clip-on docking stations for operation of a plurality of OCF canisters in an insulated environment. To protect from possible blockage of internal sections of a manifold by cooled OCF, different configurations of manifolds, such as a C-shape or star-shaped manifold, are contemplated.

### BRIEF DESCRIPTION OF THE DRAWINGS

FIG. 1 is a perspective view of a system for dispensing a one-component polyurethane foam from the prior art.

FIG. 2 is a side view of an operator handling the handheld insulated system for dispensing a one-component polyurethane foam according to a first embodiment of the present disclosure.

FIG. 3 is a front view of the operator of FIG. 2 according to the first embodiment of the present disclosure.

FIG. 4 is a superior view of the handheld insulated system for dispensing a one-component polyurethane foam as shown in FIG. 2 according to the first embodiment of the present disclosure.

FIG. 5 is a side elevation view of the handheld insulated system for dispensing a one-component polyurethane foam as shown in FIG. 2 according to the first embodiment of the present disclosure.

FIG. 6 is a side view of an operator handling a back- and waist-mounted insulated system for dispensing a one-component polyurethane foam according to a second embodiment of the present disclosure.

FIG. 7 is a side view of an operator handling a torso- and waist-mounted insulated system for dispensing a one-component polyurethane foam according to a third embodiment of the present disclosure.

FIG. 8 is a front view of the operator of FIG. 6 according to the second embodiment of the present disclosure.

FIG. 9 is a close-up view of a recharge pack and a recharge pack with straps for holding the back- and torso-mounted insulated system for dispensing a one-component polyurethane foam according to any of the possible embodiments of the present disclosure.

FIG. 10 is a dynamic illustration of the insertion or removal of a one-component polyurethane foam cartridge within a waist-mounted holster with hand gun according to any of the possible embodiments of the present disclosure.

FIG. 11 is a functional diagram of a handheld insulated system for dispensing a one-component polyurethane foam with a star-shaped manifold according to a fourth embodiment of the present disclosure.

### DETAILED DESCRIPTION

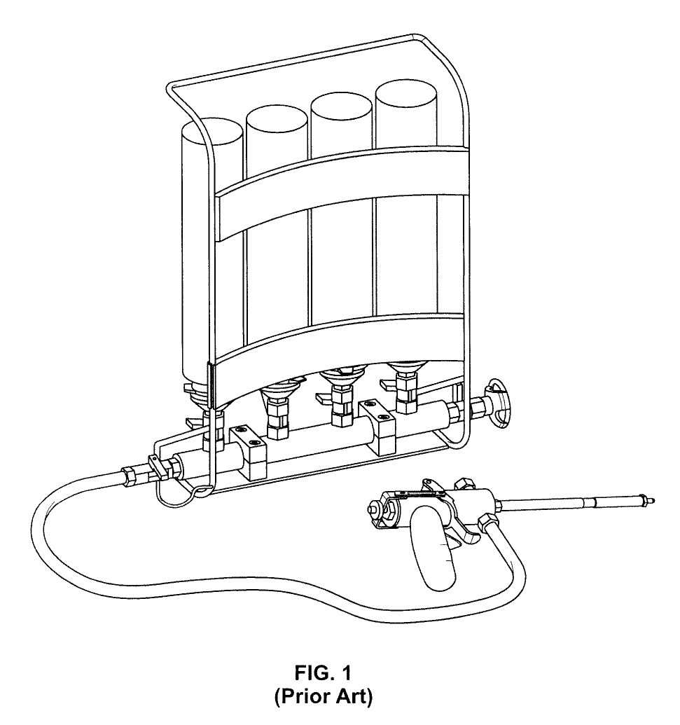

FIG. 1 shows a device called the NBS SMART BAG I®, which is marketed and sold by Altachem. This device is a back-mounted, multican dispenser with a longitudinal manifold and a control valve located at the extreme end of the manifold. The SMART BAG I® is equipped with a hand gun and a hose attached to the manifold. The entire device is not designed for easy reload or continued operation in variable temperatures. A series of four docking stations are aligned horizontally along the manifold, each for the placement of a canister of OCF. The device includes a light, wire frame with straps for mounting the bag on the back of an operator. To replace the canisters, an operator must dismount the wire frame, place it firmly on the ground, hold it in a raised position, and clip in new canisters. This device is vulnerable to ambient temperature and environmental hazards and is not designed for the continuous reloading of the canisters by the operator at a worksite. Under hot or cold conditions, the manifold temperature slowly changes in areas below canisters, and these sections may clog while other parts of the manifold are in use.

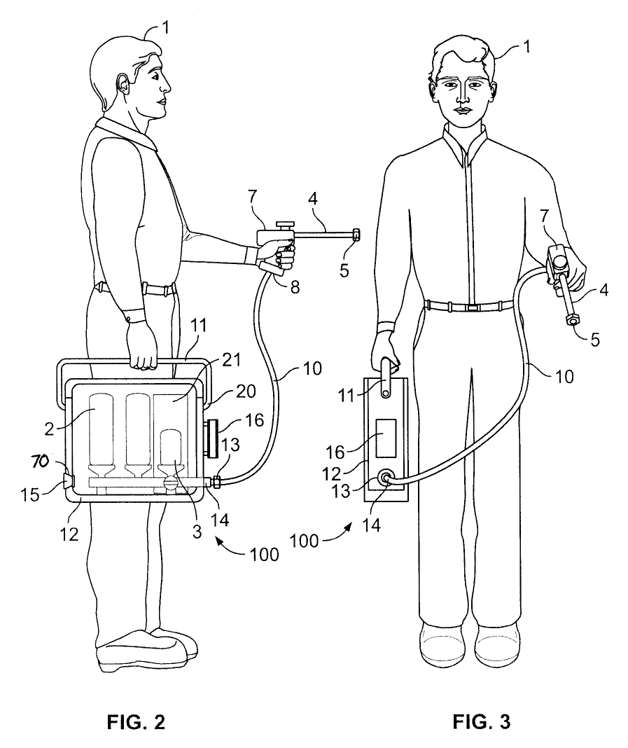

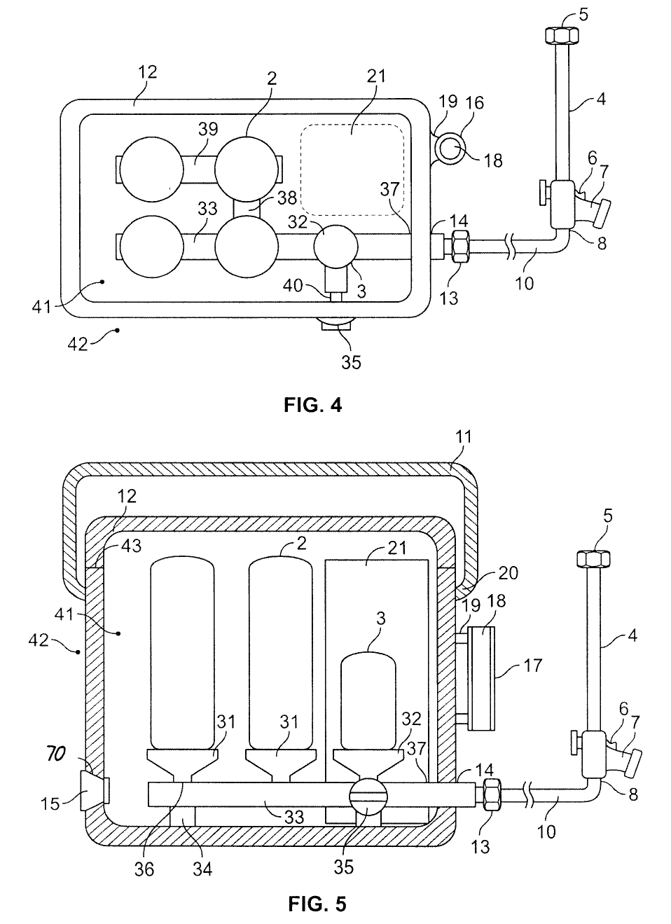

FIGS. 2-11 show several of the numerous contemplated embodiments of the present disclosure. In a contemplated embodiment shown in FIGS. 2-5, the insulated system for dispensing a one-component polyurethane foam 100 includes a handheld dispensing system made of a hose 10 connected to a valve 35 as shown in FIG. 4 at a first end 14 illustrated by a hexagonal connector 13 for rapid coupling. In one embodiment, the fitting at both ends of the hose 10 are ¼″ JIC fittings to allow easy field changes and allow for a multiplicity of hose-fed guns, wands, and valves to be used as dispensing tools. The other end of the hose 10 is connected to an end device 8 with a release mechanism 5 at a second end. What is shown is a hand gun 7 equipped with a trigger 6 and other control mechanisms located in the proximity of the hand of the operator 1. The end device 8 includes a long release neck 4 connecting the release mechanism 5 to the hand gun 7.

While one type of handheld end device 8 is shown in the form of a gun, what is contemplated is the use of any remote device capable of control of OCF for release at a destination point. In one embodiment shown in FIG. 4, the long release neck 4 allows for the use of a gun holder 16 in the shape of a hollow tube 17 as shown in FIG. 5 attached to the insulated container 12 to be, for example, slid into the opening 18 of the hollow tube 17. The gun holder 16 is attached by fixation bars 19 to the insulated container 12. What is also contemplated is the use of a wrist bands, adhesives, Velcro, holsters, a holder jacket, or any other type of holding device to secure the end device 8 to the body of the operator 1. What is also contemplated is the use of disposable elements as part of the dispensing system and the use of end tools for better control of the release of the OCF on a target. The general operation of a trigger 6 relates to a physical control mechanism such as a valve, a pinch, or a bend, which is actuated to an open configuration connecting the inside area of the OCF canister 2 with the target when the trigger 6 is pulled. One of ordinary skill in the art recognizes that while the dispensing system is not shown in FIGS. 2-11 as being protected by insulation or other thermal shields, under extreme weather conditions, the dispensing system can be insulated by a plurality of different insulation techniques.

As different types of dispensing systems may be contemplated, different models and types of foam containers 2 filled with OCF are also contemplated. What is shown is a modular system where foam containers 2 of different types, geometries, and shapes can be used in conjunction with docking stations 31 designed to operate along with the opening valves (not shown) of the foam containers 2. In the industry, it is common for manufacturers to supply different types of foam containers 2 with well-known and recognized interfaces. While such widely used interfaces are contemplated as possible best modes, the use of any other type of interface on the foam containers 2 is also contemplated, as well as the use of a specifically designed type of foam container 2 to be placed on the different docking stations 31 designed for a specific use. In the preferred embodiment, the different foam containers 2 are locked into place in the different docking stations 31 with the opening valves at a lower elevation. In most well-known, commercially available foam containers 2 available in the marketplace, the use of gravity to stabilize the liquid OCF next to the opening of the foam container 2 is known. What is also contemplated is the use of other types and technologies of foam containers 2, such as foam containers with variable location bottom plates that can be operated in the right-side-up orientation or any other orientation when, for example, a small tube is inserted in the foam container 2 uniting the valve and the bottom end of the foam container 2 for the device to be operated right-side-up for better use since the liquid is drawn from the bottom of the foam container 2. While one type of use is shown in FIGS. 2-11, what is contemplated is the capacity to attach foam containers 2 in any orientation within the insulated system for dispensing a one-component polyurethane foam 100.

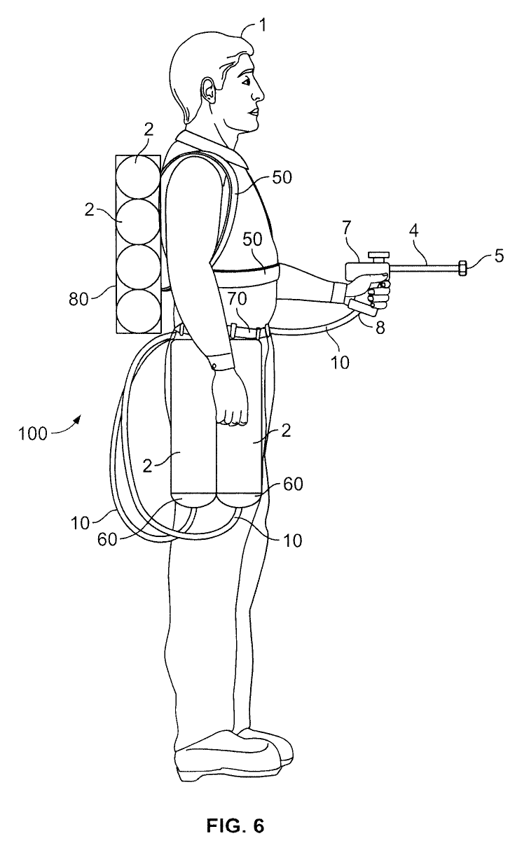

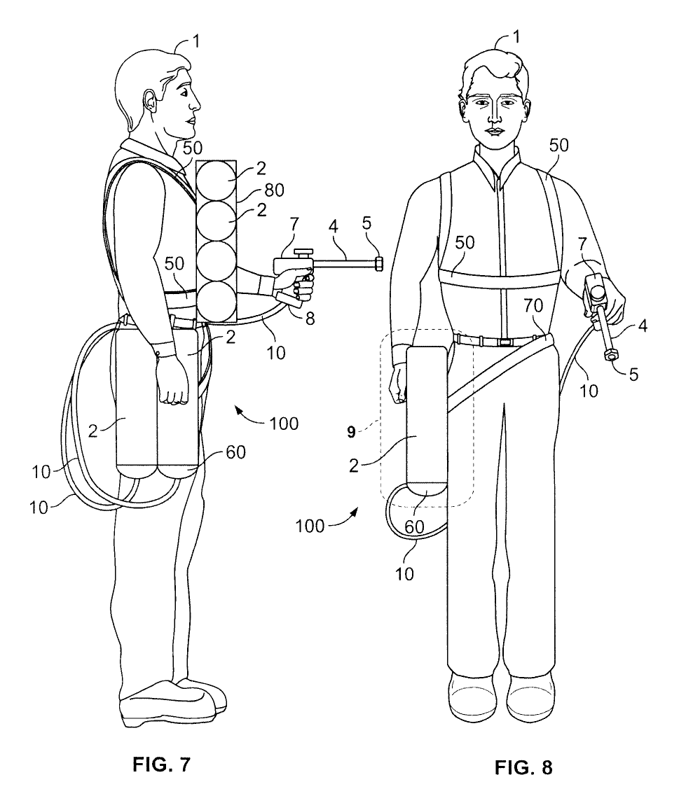

In one embodiment, the system for dispensing a one-component polyurethane foam 100 includes an insulated container 12 with a top handle 11 and a removable lid 43 as shown in FIG. 5. The insulated container 12 may also include a drain plug 15 attached to an opening 70 of the insulated container 12. In another contemplated embodiment, the opening 70 and the d-ring plug 15 also serves as a pressure relief valve. The insulated container can also include another opening 14 for allowing a manifold 33 disposed in the insulated container 12 to have access to the dispensing system located on the outside of the insulated container 12. In one embodiment, the insulated container 12 is designed to protect the interior 41 from temperature variations from exterior 42 environmental changes. What is also contemplated (but not shown) is the use of foam containers 2 designed for operation outside of normal ambient temperatures, which would require operating temperatures colder or hotter than normal or any other fixed temperature. For example, by way of nonlimiting example, if a high-pressure foam canister is used having a different carrier gas, a higher operating pressure may be needed within the insulated container 12. In that case, a heater could be added inside the interior 41 or placed in proximity to the interior 41 to provide the needed heat input. The same example is equally applicable in cold conditions. What is contemplated and disclosed is the principle of use of an insulated container 12 capable of control of the temperature of an interior 41 in comparison with an exterior 42 to ensure that adequate OCF delivery can be obtained based on the optimal temperature of operations. What is also shown in FIGS. 6-9 is the use of boxes 80 attached to an operator 1. What is shown is the use of a box 80 mounted on either the torso as shown in FIG. 7 or the back as shown in FIG. 6 using straps 50. These boxes are generally made of a thin layer of paper, cardboard, wood, plastic, or any other material that encloses a volume of air within its volume. This volume of air, in contact with a series of foam containers 2 at an adequate temperature, transfers part of the foam containers' heat to the volume or air and creates a buffer zone of convective heat resistance. By placing the box 80 against the operator 1, part of the box 80 is in direct contact with the external environment while the other side of the same box 80 is in contact with the body of the operator 1.

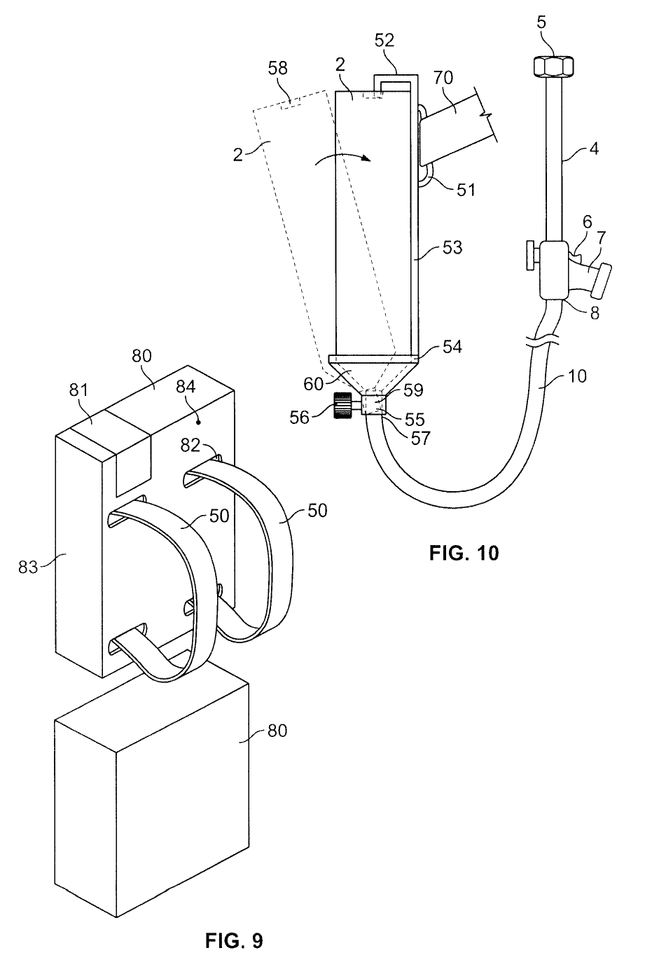

FIG. 9 is a detailed illustration of one possible embodiment of this supply box 80 having a detachable opening 81 for easy access to and removal of any quantity of foam containers 2 from within the box. What is also shown is the use of two straps 50 across the body of the box 80 for mounting the supply box 80 on the back or torso of an operator 1. While one pair of straps 50 is shown, what is contemplated is the use of any type and geometry of opening 82 within the face 84 of the box 80 for mounting the foam canister on the operator 1. What is also contemplated is the use of metal harnesses, plugs, holders, bars, adhesives, or pouch systems to hold the different containers next to the body of the operator 1. To illustrate this general principle, a vest with a transparent pouch for insertion of foam containers 2 can be used where foam containers 2 or a box 80 can be inserted. Once again, the general principle of this disclosure supersedes the different embodiments shown and relates to the placement of a plurality of foam containers 2 in close proximity to an operator 1 with a distribution system with easy access and capability of resupply while working on a specific worksite under either heat-controlled conditions or insulated conditions.

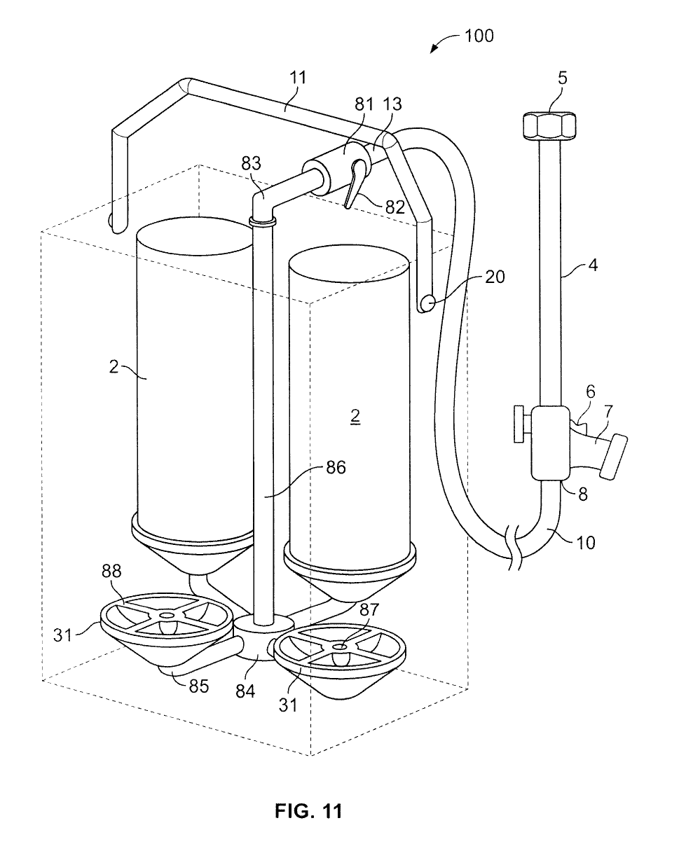

In yet another embodiment, FIG. 11 shows in dashed lines a transparent insulating container with a handle 11 attached pivotally 20 to the container. In FIGS. 6-8, what is also contemplated is the use of a shoulder or waist strap for holding the insulated container 12 in place of the handle 11. Returning to FIGS. 2-5, a plurality of docking stations 31 are connected to a common plenum, such as a manifold 33. In one embodiment, a control valve 35 can be placed along the manifold 33 to help regulate the flow of OCF by the system. For example, as shown in FIG. 4, a three-way valve 35 (having off/foam/clean settings) placed outside of the insulated container 12 can be turned via a contactor 40 to close access of the foam containers 2 with the opening 14 where the OCF is ultimately dispensed by the dispensing system and instead contact a canister of gun cleaner container 3 with the dispensing system for cleaning when the trigger 6 is pressed and part of the gun cleaner container 3 flows out of the canister. In one preferred embodiment, the foam containers contain 750 ml of OCF foam and the gun cleaner container 3 contains 12 fluid ounces of a cleaning agent located on a docking inlet for releasably connecting the cleaning container to the manifold 33 via a docket inlet 32. In yet another embodiment, the manifold 33 can be replaced or cleaned outside of the insulated container 12. What is not shown is the different attachment means employed to hold a removable or replaceable manifold 33, since the technique associated with the temporary placement or removing of a manifold is known in the art. FIG. 4 also shows in another contemplated embodiment an insulated container 12 having temporary storage 21 for placement of items such as gloves, eye protection gear, gun lip gear, or extra cartridges for cleaning or foaming. The manifold 33 is also shown in a C-shaped configuration or understandably any nonlinear configuration where a branch 38 and a branch 39 are attached to the principal manifold 33. This configuration allows for the use of foam containers 2 even if part of the manifold between two consecutive foam containers 2 is clogged. In one contemplated embodiment, the docking stations 31 are equipped with a pressure relief valve. In yet another contemplated embodiment, the docking stations 31 may include sectioning valves to regulate the flow of OCF to ensure that only a single foam container 2 dispenses at a time. The different foam containers 2 are releasably connected to each of the docking stations 31 by a click-in action as shown in dashed lines in FIG. 10.

In another embodiment, the portable system for dispensing a one-component polyurethane foam 100 shown as FIGS. 6-10 includes a rack 52 including a vertical support 53, a holster 51 connected to the vertical support 70, and a manifold support 54 connected to the vertical support 53. The manifold 59 is also connected to the manifold support 54 with a plurality of docking stations 60 connected to a valve 56. The plurality of foam containers 2 also include a one-component polyurethane foam (not shown but located inside the foam container 2, each releasably connected to each of the plurality of docking stations 60. The system 100 also includes a dispenser held by an operator 1 shown as a hose 10 connected to the valve 56 at a first end 57 and an end device 5 with a release mechanism such as a trigger 6 at a second end. The system 100 also includes a portable recharge pack 80 shown in FIG. 9 and worn by the operator 1 as shown in FIG. 6. This portable recharge pack 80 includes a plurality of replacement foam containers 2 containing one-component polyurethane foam, which are shown stacked horizontally on top of each other and adapted to be worn by a user or an operator 1. The plurality of foam containers 2 is disconnected from the docking station and replaced by one of the plurality of replacement foam containers 2 from the portable recharge pack once the one-component polyurethane foam is discharged from the foam container 2.

The system 100 as shown in FIGS. 6-10 is designed to be portable and mounted on the body of the operator 1 for easy use at a workstation. What is not shown but contemplated is the use of a holster located at the belt to attach the dispensing system. In one contemplated embodiment, boxes 80 containing 4 foam containers 2 are shown. One possible way to dispense from the foam container 2 is by creating an opening to the box either at the lower end or at a top end. An operator 1 can reach back and pull a container from the bottom end of the box 80. The top three foam containers 2 then fall down and create an opening on the top end of the box 80 where an empty foam container 2 from the belt area can be reinserted in the box 80 for storage. What is shown is the placement within the belt holster 52 of a device capable of storage of two different foam containers 2 on two docking stations 60, each connected to a different hose 10. In another embodiment, both docking stations 60 are connected via a common manifold 59 into a single hose 10. In yet another embodiment, three foam containers 2 can be attached to the belt in a pyramid configuration and used either with a triangular manifold 59 or three different hoses with a selector at the belt area 70. In the embodiment shown in FIGS. 6-10, what is contemplated is the insertion of foam containers 2 in the belt area 70 on the belt holster 52 when OCF must be delivered. The foam containers are kept at an insulated temperature during transportation in the box 80 located on either the back as shown in FIG. 6 or the torso as shown in FIG. 7. In yet another embodiment, if an operator needs to transport more foam containers, what is contemplated is the use of both a back and a torso box 80 used concurrently. What is also contemplated is the placement of two foam containers 2 in the belt area 70 during transportation. Other external insulation methods such as a covering pouch, a covering box, or a covering bag (not shown) can be used to control the temperature of the two foam containers 2 during the transportation in the belt area 70. What is also contemplated is the use of a cleaner container that can be attached to the manifold 59 located below the two foam containers 2. What is disclosed and contemplated is the use of thermal insulation and belt area support to help an operator 1 during OCF delivery manipulations. The system as contemplated allows for easy recharge, transportation, and delivery of OCF by an operator 1 even if located high on a ladder or in a remote location where repeated access for resupply is difficult. By not placing the manifold 59 in the back area, the delivery system is protected from shocks and the operator 1 can move backwards or down from a perched location without fear of damaging the different controls associated with the system 100.

In one embodiment, the rack 52 further includes a holster (not shown) adapted to retain a portion of the dispenser system instead of placing the dispenser system directly on the belt. In one embodiment, the box is a cardboard shipping box containing six different containers of foam 2 each of 750 ml. The straps 50 can also be reusable straps. In yet another embodiment, the foam containers 2 are mounted on the docking station 60 using an underhook means such as a push-and-latch-to-activate means. Alternatively, the foam containers 2 are mounted using a standard screw-in connector (not shown). In one embodiment, a hose of ¼″ in diameter with JIC type fittings is disclosed.

In yet another embodiment shown as FIG. 11, the system for dispensing a one-component polyurethane foam 100 includes a star-shaped manifold 84 including a plurality of docking stations 31, each of the docking stations located on a different radial branch 85 of the star-shaped manifold 84 having a plurality of foam containers containing one-component polyurethane foam, each foam container releasably connected to each of the docking stations 31, and a dispenser including a distribution line 86 having a entry end connected to the manifold 84 and an exit end 83 connected to a dispense valve 81 shown with a tab. A hose 10 is then connected to the dispensing valve 82 at a first end 13 and to an end device 5 with a release mechanism such as a trigger 6 at a second end, wherein each of the plurality of foam containers 2 is disconnected form the docking station 31 and replaced by a new foam container 2 once the one-component polyurethane foam is discharged from the foam container. In one embodiment, the star-shaped manifold 84 further includes a selection valve (not shown) used to select which foam container 2 dispenses foam at any given moment. In yet another embodiment, the use of a cleaning fluid contained in a canister is contemplated (not shown). The cleaning container can be placed at any of the branches 85 on the manifold 84. The dashed line is understood to be an insulated container 12 as described above.

It is understood by one of ordinary skill in the art that these different elements correspond to the general elements found in this disclosed system to practice this disclosure. Other auxiliary elements and limitations may be imagined and contemplated to operate this system, but they do not affect the validity and completeness of the disclosure of this system. Persons of ordinary skill in the art appreciate that although the teachings of the disclosure have been illustrated in connection with certain embodiments, there is no intent to limit the invention to such embodiments. On the contrary, the intention of this application is to cover all modifications and embodiments falling fairly within the scope of the teachings of the disclosure.

What is claimed is:

1. A system for dispensing a one-component polyurethane foam, comprising:
an insulated container including a handle and a removable lid;
a manifold disposed in the insulated container including a plurality of docking stations connected to a common plenum, and a valve;
a plurality of foam containers including a one-component polyurethane foam, each releasably connected to each of the docking stations; and
a dispenser including a hose connected to the valve at a first end and to an end device with a release mechanism at a second end,
wherein each of the plurality of foam containers is disconnected from the docking station and replaced by a new foam container once the one-component polyurethane foam is discharged from the foam container.

2. The system for dispensing a one-component polyurethane foam of claim 1, further comprising a cleaning container having a cleaning agent, and wherein the manifold further includes a docking inlet for releasably connecting the cleaning container.

3. The system for dispensing a one-component polyurethane foam of claim 2, wherein the dispensing valve is a three-way valve having an open position to connect one of the plurality of foam containers to the dispenser, a cleaning position to connect the cleaning container to the dispenser, and a closed position.

4. The system for dispensing a one-component polyurethane foam of claim 1, wherein the end device is a hand gun and the release mechanism is a trigger.

5. The system for dispensing a one-component polyurethane foam of claim 1, wherein the manifold is C-shaped and each of the plurality of docking stations are located at different sections of the manifold.

6. The system for dispensing a one-component polyurethane foam of claim 1, wherein the insulated container further includes a holster adapted to retain a portion of the dispenser.

7. The system for dispensing a one-component polyurethane foam of claim 1, wherein the insulated container further includes a pressure relief valve.

8. The system for dispensing a one-component polyurethane foam of claim 1, wherein the handle is adapted to be secured to a holster.

9. The system for dispensing a one-component polyurethane foam of claim 1, wherein the insulated container further includes a storage area.

10. A portable system for dispensing a one-component polyurethane foam, comprising:
a rack including a vertical support, a holster connected to the vertical support, and a manifold support connected to the vertical support;
a manifold connected to the manifold support including a plurality of docking stations connected to a valve;
a plurality of foam containers including a one-component polyurethane foam, each releasably connected to each of the plurality of docking stations;
a dispenser including a hose connected to the dispensing valve at a first end and an end device with a release mechanism at a second end; and
a portable recharge pack having a plurality of replacement foam containers of one-component polyurethane foam, the portable recharge pack being adapted to be worn by a user,
wherein each of the plurality of foam containers is disconnected from the docking station and replaced by one of the plurality of replacement foam containers from the portable recharge pack once the one-component polyurethane foam is discharged from the foam container.

11. The portable system for dispensing a one-component polyurethane foam of claim 10, wherein the system further includes a holster adapted to retain a portion of the dispenser.

12. The portable system for dispensing a one-component polyurethane foam of claim 10, wherein the end device is a hand gun and the release mechanism as a trigger.

13. The portable system for dispensing a one-component polyurethane foam of claim 10, wherein the portable recharge pack is a container supply package and includes a shoulder strap used to adapt the portable recharge pack to the user.

14. The portable system for dispensing a one-component polyurethane foam of claim 14, wherein the shoulder strap is inserted in an opening in the container supply package.

15. The portable system for dispensing a one-component polyurethane foam of claim 10, wherein the support rack further includes a holster adapted to retain a portion of the dispenser.

16. A system for dispensing a one-component polyurethane foam, comprising:
a star-shaped manifold including a plurality of docking stations, each of the docking stations located on a different radial branch of the star-shaped manifold;
a plurality of foam containers including a one-component polyurethane foam, each releasably connected to each of the docking stations; and
a dispenser including a distribution line having a entry end connected to the manifold and an exit end connected to a dispensing valve, a hose connected to the dispensing valve at a first end and to an end device with a release mechanism at a second end,
wherein each of the plurality of foam containers is disconnected form the docking station and replaced by a new foam container once the one-component polyurethane form is discharged from the foam container.

17. The system for dispensing a one-component polyurethane foam of claim 17, wherein the star-shaped manifold further includes a selection valve.

18. The system for dispensing a one-component polyurethane foam of claim 17, further comprising an insulated container including a handle and a removable lid, wherein the manifold is disposed in the insulated container.

19. The system for dispensing a one-component polyurethane foam of claim 17, wherein the end device is a hand gun and the release mechanism is a trigger.

20. The system for dispensing a one-component polyurethane foam of claim 19, wherein the insulated container further includes a holster adapted to retain a portion of the dispenser.

21. The system for dispensing a one-component polyurethane foam of claim 19, wherein the insulated container further includes a pressure relief valve.

22. The system for dispensing a one-component polyurethane foam of claim 19, wherein the handle is adapted to be secured to a scaffold.

23. The system for dispensing a one-component polyurethane foam of claim 19, wherein the insulated container further includes a storage area.
